(19) United States
(12) Patent Application Publication
(10) Pub. No.: US 2004/0044427 A1
(43) Pub. Date: Mar. 4, 2004

(54) Method for transmission of audio signals

(76) Inventor: Hans-Jurgen Neuhaus, Berlin (DE)

Correspondence Address: BELL, BOYD & LLOYD, LLC, P. O. BOX 1135, CHICAGO, IL, 60690-1135, US

(21) Appl. No.: 10/332,882

(22) PCT Filed: Jun. 29, 2001
(86) PCT No.: PCT/DE01/02432

(30) Foreign Application Priority Data
Jul. 12, 2000 (DE) 10034323.6

(51) Int. Cl. H04B 3/00; G06F 17/00

(52) U.S. Cl. 700/94; 381/77

(57) ABSTRACT

A method is provided for transmitting audio signals from at least one hi-fi signal source to at least one hi-fi signal sink, wherein the audio signals are compressed in the MP3 compression standard and then transmitted from the at least one hi-fi signal source to the at least one hi-fi signal sink via the Bluetooth radio standard and in a single Bluetooth radio channel.

### BACKGROUND OF THE INVENTION

The present invention relates to a method for transmitting of audio signals from at least one hi-fi signal source to at least one hi-fi signal sink, in which the audio signals are transmitted from the at least one hi-fi signal source to the at least one hi-fi signal sink in a manner compressed in a digital radio standard.

Such a method is disclosed in the published European patent application 0 865 170 A1. In this previously known method, audio information from a hi-fi system operating as a hi-fi signal source is firstly compressed to the ATRAC method. The audio signals compressed in this way are subsequently transmitted in the DECT standard (DECT: Digital Enhanced Cordless Telecommunications) to a hi-fi signal sink. The hi-fi signal sink may be, by way of example, headphones, a loudspeaker or an amplifier.

This published patent application additionally discloses a hi-fi signal sink with a receiving device for receiving compressed radio transmitted audio signals from a hi-fi signal source.

Moreover, this published application discloses a hi-fi signal source with a radio device for transmitting compressed audio signals to a hi-fi signal sink.

The present invention is directed toward a method for the transmission of audio signals in which audio signals from a number of hi-fi signal sources can be transmitted simultaneously to a hi-fi signal sink or to a number of hi-fi signal sinks.

The present invention is also directed toward a hi-fi signal sink with a receiving device for receiving compressed radio transmitted audio signals from a hi-fi signal source wherein the audio signals from a number of hi-fi signal sources can be received simultaneously.

The present invention is further directed toward a hi-fi signal source with a radio device for transmitting compressed audio signals to a hi-fi signal sink wherein the source can be operated together with further hi-fi signal sources such that audio signals from a number of hi-fi signal sources can be transmitted simultaneously to one or a number of hi-fi signal sinks.

### SUMMARY OF THE INVENTION

Proceeding from a method of the type specified in the introduction, the radio standard used by the present invention is the Bluetooth radio standard, and all the audio signals are transmitted in a manner compressed in the MP3 compression standard in a single Bluetooth radio channel. The “Bluetooth” transmission technique is described in Funkschau 23/99 “Code-Name Bluetooth”, pages 80 and 81, by W. Schulte, and in Funkschau 13/99 “Die ersten Bluetooth-Produkte”, [“The first Bluetooth products”], pages 38 and 39, by M. Kotynek-Friedl. In this case, the “MP3 compression” is understood to be compression according to the MPEG layer 3 standard (ISO-MPEG Audio Layer 3 (e.g. IS11172-3 or IS13818-3)).

A key advantage of the method according to the present invention is that MP3 data compression is combined with the Bluetooth radio standard, because the data rate of an audio signal which is compressed according to the MP3 standard is matched very well to the transmission rate of a Bluetooth radio channel. Thus, the data rate of a stereo audio channel after MP3 data reduction is approximately 100 kilobits per second and is, thus ideally matched to the transmission rate of a Bluetooth channel, which has a data rate of up to one megabit per second. In the case of the method according to the present invention, therefore, it is possible to transmit the audio signals from a number of hi-fi signal sources simultaneously in a single Bluetooth radio channel, to be precise up to 10 different audio signals in parallel. If one of the hi-fi signal sinks is a set of hi-fi headphones, for example, then the user of the hi-fi headphones could, in each case select the audio signal which he/she would actually like to hear. To summarize, in the case of the method according to the present invention, in contrast to the previously known DECT transmission method, it is always the case that use is only ever made of a single Bluetooth radio channel. As a result, a flexible system is achieved in which audio signals from different hi-fi signal sources can be received simultaneously.

It is advantageous if a remote control device is used for driving the at least one hi-fi signal source and/or the at least one hi-fi signal sink, which device transmits its control signals in the Bluetooth radio channel to the at least one hi-fi source and/or to the at least one hi-fi signal sink. This is because, in accordance with this development of the method according to the present invention, the Bluetooth radio channel that is present anyway for the transmission of the audio signals is additionally used also for the transmission of control signals.

Also according to the present invention, a signal sink is used which is suitable for the reception and reproduction of audio signals which are compressed according to the MP3 compression standard and are transmitted according to the Bluetooth radio standard, such that audio signals from a number of hi-fi signal sources can be received_simultaneously.

The present invention incorporates a hi-fi signal source which is suitable for the compression of the audio signals according to the MP3 compression standard and for the transmission of the compressed audio signal according to the Bluetooth radio standard, wherein the source can be operated together with hi-fi signal sources such that audio signals from a number of hi-fi signal sources can be transmitted simultaneously to one or a number of hi-fi signal sinks.

Additional features and advantages of the present invention are described in, and will be apparent from, the following Detailed Description of the Invention and the Figures.

### BRIEF DESCRIPTION OF THE FIGURES

FIG. 1 shows an exemplary embodiment of an arrangement which can be used to carry out the method according to the present invention.

FIG. 2 shows an exemplary embodiment of a hi-fi signal sink according the present invention.

FIG. 3 shows an exemplary embodiment of a hi-fi signal source according to the present invention.

### DETAILED DESCRIPTION OF THE INVENTION

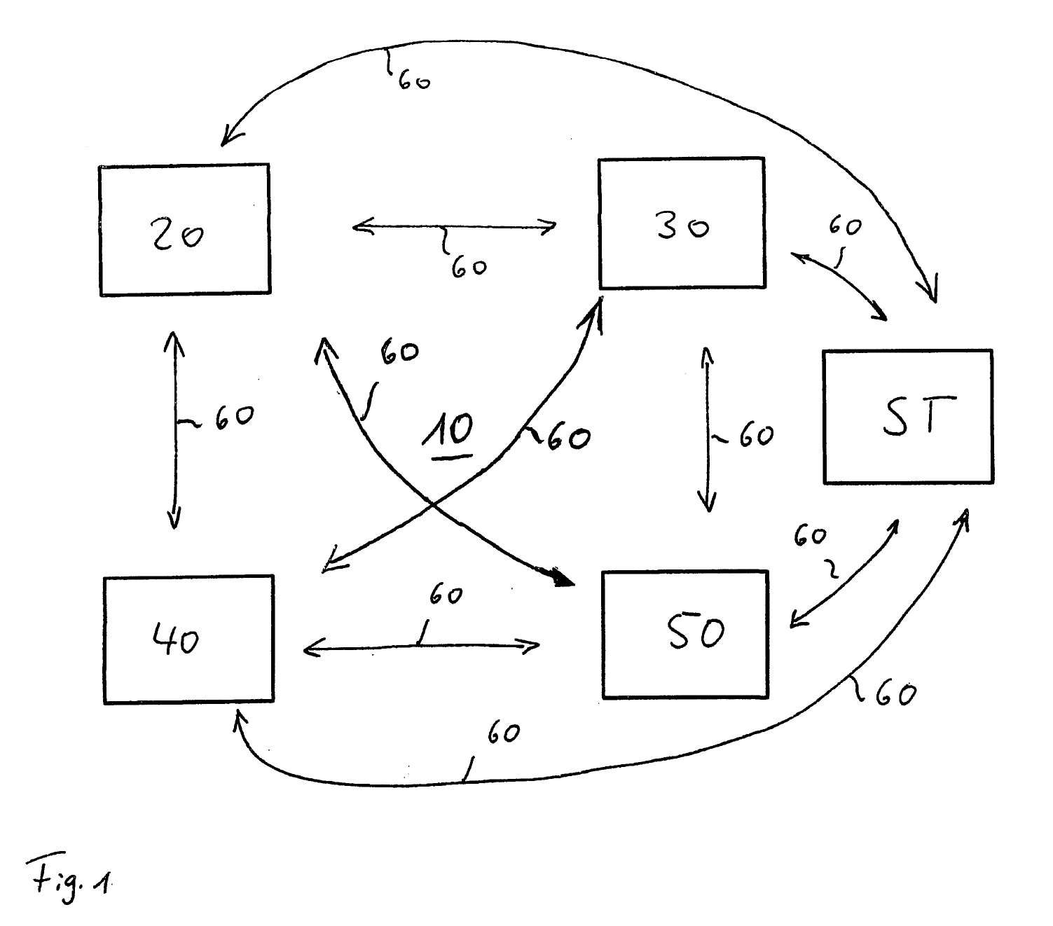

FIG. 1 shows a Bluetooth microcell 10, which is formed by a hi-fi signal source 20, a further hi-fi signal source 30, a hi-fi signal sink 40 and a further hi-fi signal sink 50 and a remote control device ST. The two hi-fi single sources, the two hi-fi signal sinks and the remote control device ST are in a Bluetooth radio connection among one another, which is represented diagrammatically in FIG. 1 by arrows bearing the reference symbol 60. In this case, the Bluetooth radio connection is formed by a single Bluetooth radio channel. In this Bluetooth radio channel, the data signals are transmitted with a data rate of up to one megabit per second.

As can be gathered from FIG. 1, the one hi-fi signal source 20 is connected both to the one signal sink 40 and to the further signal sink 50. The same applies to the further signal source 30, which is connected both to the one signal sink 40 and to the further signal sink 50. Thus, the audio signals from both hi-fi signal sources 20 and 30 are present at each of the two signal sinks 40 and 50, so that the audio information from both hi-fi signal sources can be received by each of the two signal sinks.

This will be illustrated using an example. If the one signal source 20 is a CD player, for example, and the further hi-fi signal source 30 is a radio, then both the audio information from the CD player and the audio information from the radio can be received in both hi-fi signal sinks 40 and 50. If the two hi-fi signal sinks 40 and 50, respectively, are headphones, for example, then a user of the headphones can decide such as by a corresponding switching device which audio information he/she would like to receive. Thus, the user can decide whether he/she wishes to receive the audio information from the CD player 20 or the audio information from the radio 30. With the control device ST, the user can additionally generate control signals for driving the two signal sinks 40 and 50 and the two signal sources 20 and 30.

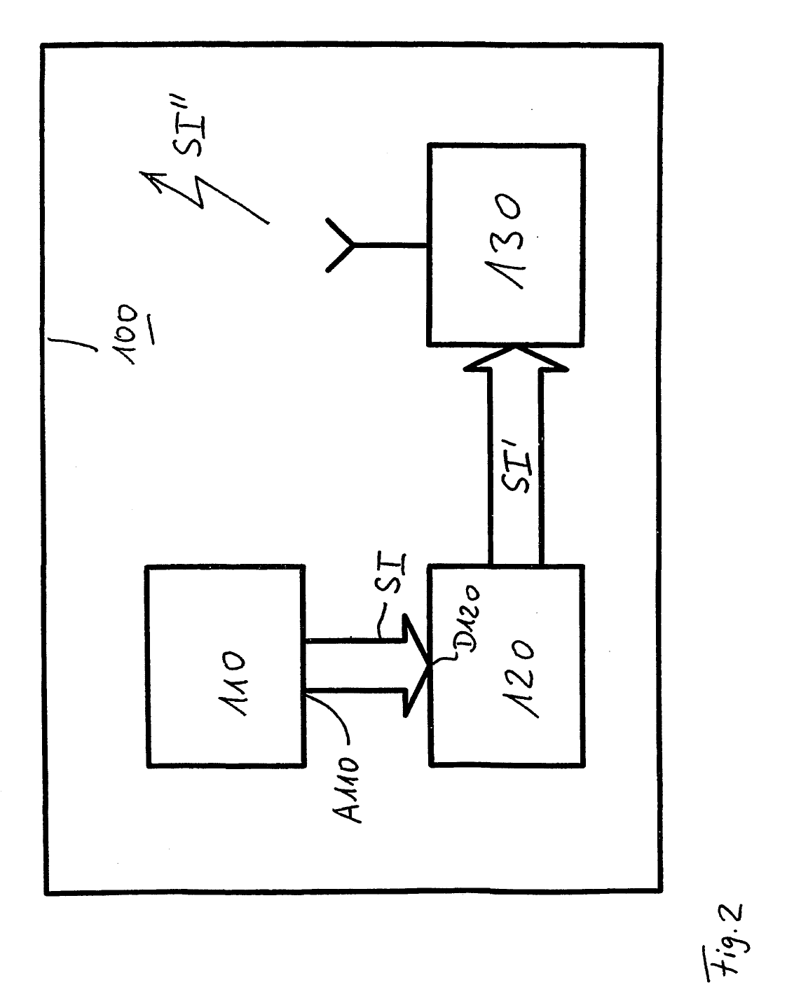

FIG. 2 illustrates an exemplary embodiment of a hi-fi signal source 100. The hi-fi signal source 100 has an audio signal source 110, which may be, by way of example, a CD player, a radio, a disc player or the like. The audio signal source 110 is connected by its signal output A110 to a data input D120 of an MP3 coding device 120. A Bluetooth radio device 130 is arranged downstream of the MP3 coding device 120 on the output side.

The hi-fi signal source 100 can be operated as follows. Audio information SI from the audio signal source 110 pass via the output A110 of the audio signal source 110 to the MP3 coding device 120. In the MP3 coding device 120, the audio information is subjected to MP3 coding to form compressed audio signals SI′. The compressed audio signals SI′ pass to the Bluetooth radio device 130, which transmits the compressed audio signals SI′ as Bluetooth radio signals SI″.

FIG. 3 shows an exemplary embodiment of a hi-fi signal sink 200. The hi-fi signal sink 200 has a Bluetooth receiving device 210, downstream of which is connected, at an output A210, an MP3 decoding device 220 by its data input D220. On the output side, the MP3 decoding device 220 device is connected to an audio reproduction device 230, which may be, by way of example, a set of headphones, a loudspeaker or an amplifier. The hi-fi signal sink in accordance with FIG. 3 can be operated as follows. The Bluetooth receiving device 210 receives Bluetooth radio signals SI″, which may originate, for example, from a hi-fi signal source such as that in accordance with FIG. 2. The Bluetooth radio signals SI″ pass to the MP3 decoding device 220, in which decoded audio signals SI′″ are obtained from the Bluetooth radio signals. The decoded audio signals SI′″ pass to the audio reproduction 230, which converts the decoded audio signals SI′″ into acoustic waves, for example, and outputs the latter.

Although the present invention has been described with reference to specific embodiments, those of skill in the art will recognize that changes may be made thereto without departing from the spirit and scope of the present invention as set forth in the hereafter appended claims.

5. A method for transmitting audio signals from at least one hi-fi signal source to at least one hi-fi signal sink, the method comprising the steps of:
compressing the audio signals in an MP3 compression standard; and
transmitting the compressed audio signals from the at least one hi-fi signal source to the at least one hi-fi signal sink via a Bluetooth radio standard and in a single Bluetooth radio channel.

6. A method for transmitting audio signals from at least one hi-fi signal source to at least one hi-fi signal sink as claimed in claim 5, the method further comprising the step of driving at least one of the at least one hi-fi signal source and the at least one hi-fi signal sink, via a remote control device, wherein the remote control device transmits control signals in the single Bluetooth radio channel to the respective at least one hi-fi signal source and the at least one hi-fi signal sink.

7. A hi-fi signal sink, comprising a receiving device for receiving compressed radio-transmitted audio signals from a hi-fi signal source, wherein the hi-fi signal sink may receive and reproduce the audio signals which are compressed according to an MP3 compression standard and are transmitted according to a Bluetooth radio standard.

8. A hi-fi signal source, comprising a radio device for transmitting compressed audio signals to a hi-fi signal sink, wherein the hi-fi signal source may compress the audio signals according to a MP3 compression standard and may transmit the compressed audio signals according to a Bluetooth radio standard.
